(19) United States
(12) Patent Application Publication
(10) Pub. No.: US 2005/0025682 A1
(43) Pub. Date: Feb. 3, 2005

(54) Chemical reaction apparatus

(75) Inventors: Kenji Essaki, Kanagawa-ken (JP); Masahiro Kato, Kanagawa-ken (JP); Sawako Yoshikawa, Kanagawa-ken (JP); Kazuaki Nakagawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 10/875,317

(22) Filed: Jun. 25, 2004

(30) Foreign Application Priority Data
Jun. 27, 2003 (JP) 2003-184783

(51) Int. Cl. B01J 8/00

(52) U.S. Cl. 422/190; 422/211; 48/127.9

(57) ABSTRACT

A chemical reaction apparatus includes a reaction chamber and a carbon dioxide absorbent chamber disposed behind the reaction chamber in adjacent to it. The reaction chamber generates a gas containing hydrogen and carbon dioxide from the material gas, and the carbon dioxide absorbent chamber absorbs carbon dioxide from the gas generated from the reaction chamber.

### CROSS-REFERENCE TO RELATED APPLICATION

This application is based upon and claims the benefit of priority from the prior Japanese Patent Applications No. JP2003-184783, filed on Jun. 27, 2003; the entire contents of which are incorporated herein by reference.

### FIELD OF THE INVENTION

The present invention relates to a chemical reaction apparatus for generating hydrogen from a material gas. More particularly, the present invention relates to a chemical reaction apparatus capable of increasing the recovery ratio of a main product by improving a reaction efficiency by separating hydrogen generated as a main product from the material gas from carbon dioxide generated as a by-product.

### DESCRIPTION OF THE BACKGROUND

In general, many of reactions, which generate carbon dioxide as a by-product in a reaction for generating hydrogen as a main product from a raw material containing carbon monoxide and from a raw material containing carbon hydride, are well known, and these reactions have been applied to actual apparatuses or it is examined to apply them to actual apparatuses.

For example, in a combustion system used in a steam-power generation system, there is proposed a system which executes a reforming reaction for generating hydrogen as a main product and carbon dioxide or carbon monoxide as a by-product by reacting fossil fuel as a raw material before it is combusted and further combusts the fossil fuel by mixing it with air. Alternatively, in chemical industries, there is a process employing a shift reaction for generating hydrogen as a main product and carbon dioxide as a by-product by reacting carbon monoxide as a raw material with water. In the system and process, the hydrogen yield as the main product generated from the raw material must be increased.

To cope with the above request, there is a method of effectively obtaining a main product in a chemical reaction for executing a reaction for generating hydrogen as the main product and carbon dioxide as a by-product from a material gas by removing the carbon dioxide from a reaction field using an inorganic carbon dioxide absorbent, for example, lithium silicate and the like together with a solid catalyst for the reaction, which is disclosed in Japanese Patent disclosure (Kokai) No. 2002-274809 (Patent Document 1, henceforth), Japanese Patent disclosure (Kokai) No.10-152302 (Patent Document 2, henceforth) and the like.

This method has an effect of increasing the hydrogen yield as the main product making use of a phenomenon that chemical equilibrium shifts to a main product generating side by removing the carbon dioxide from the reaction field.

Further, when lithium silicate, for example, is used as the carbon dioxide absorbent, the reaction, in which carbon dioxide reacts with the carbon dioxide absorbent and is absorbed thereby, is an exothermic reaction. Accordingly, when the carbon dioxide absorbent exists in the reaction field in the reaction for generating hydrogen from the material gas, there is also an effect of reducing a heat loss because heat necessary to generate hydrogen can be compensated with the heat generated by the carbon dioxide absorbent when it absorbs carbon dioxide, in addition to an effect of increasing the hydrogen yield.

As a method of using the carbon dioxide absorbent in addition to a solid catalyst in the generation of hydrogen, it is contemplated to use a method of mixing the solid catalyst with the carbon dioxide absorbent and filling the mixture thereof (refer to Patent Document 1) and a method of filling with the solid catalyst and the carbon dioxide absorbent separately (refer to Patent Document 2).

The former method of mixing the solid catalyst with the carbon dioxide absorbent and filling the mixture thereof is desirable to explicitly realize the two effects described above. However, the method is disadvantageous in that when the solid catalyst is mixed with the carbon dioxide absorbent and the mixture thereof is used for the filling, their capability is deteriorated when they are used for a long period.

That is, since the solid catalyst is ordinarily a porous member and lithium silicate, which is suitable as the carbon dioxide absorbent, generates molten carbonate in use, when absorption and regeneration are executed, the carbonate moves to the pores of the solid catalyst and clogs them. Therefore, the specific surface area of the solid catalyst is reduced thereby as well as the reactive component of the carbon dioxide absorbent is decreased. When the carbon dioxide absorbent is used for a long period while repeating the absorption and the regeneration therein, the effect of movement of the molten carbonate is outstanding, thereby the capability of the solid catalyst and the carbon dioxide absorbent is deteriorated.

In contrast, the latter method of separately filling with the solid catalyst and the carbon dioxide absorbent prevents the deterioration of capability thereof due to the movement of molten carbonate, it is difficult to explicitly realize the above two effects. For example, Patent Document 2 discloses a method of arranging an inner pipe, which is filled with the solid catalyst, and an outer pipe, which is filled with the carbon dioxide absorbent, as a double pipe structure and making a wall between the inner pipe and the outer pipe porous so that a gas passes therethrough. In this method, however, only a part of the gas, which has reacted with the solid catalyst in the inner tube, passes through the outer pipe, and, in particular, when a large amount of the gas flow, an effect of shifting the chemical equilibrium is difficult to explicitly appear.

From what has been described above, there is required a system that can secure the hydrogen yield by an effect of shifting chemical equilibrium in a state where a carbon dioxide absorbent is not in direct contact with a solid catalyst as well as can effectively utilize heat generated in respective reactions and can suppress a heat loss.

### BRIEF SUMMARY OF THE INVENTION

The present invention is directing to provide a chemical reaction apparatus that does not deteriorate the hydrogen yield when the apparatus is used for a long period as compared with a conventional apparatus in a chemical reaction apparatus employing a system for improving the hydrogen yield as a main product by absorbing carbon dioxide as a by-product using a carbon dioxide absorbent in a reaction process for generating hydrogen from a material gas.

According to an aspect of the present invention, there is provided a chemical reaction apparatus that includes a reaction chamber for generating a first gas containing hydrogen as a main product and carbon dioxide as a by-product by causing a material gas to come into contact with a catalyst, and a carbon dioxide absorbent chamber disposed adjacent to the reaction chamber, having one of a gas flow path or a gas flow hole for introducing the first gas generated in the reaction chamber there into, generating a second gas by selectively absorbing the carbon dioxide as the by-product from the first gas by a carbon dioxide absorbent, and having a generated gas discharge port for taking out the second gas, wherein the carbon dioxide absorbent chamber is disposed behind the reaction chamber.

According to an other aspect of the present invention, there is provided to a chemical reaction apparatus for effectively obtaining a main product making use of a phenomenon that chemical equilibrium shifts to the side where the main product is generated by removing carbon dioxide from a reaction field in a chemical reaction in which hydrogen as the main product and carbon dioxide as the by-product are generated from a raw material by using an inorganic carbon dioxide absorbent together with a catalyst for the above reaction.

More specifically, when, for example, methane is reformed using steam, a reaction shown in Expression (1) occurs at about 600° C. at an atmospheric pressure under the existence of a solid catalyst, and this reaction is an endothermic reaction. When only the solid catalyst is used at the above temperature, the reaction does not proceed rightward perfectly.
CH₄+2H₂O [symbol] 4H₂+CO₂-Q (1)

In contrast, when lithium silicate is used as the carbon dioxide absorbent, the lithium silicate is decomposed to a compound containing lithium carbonate and silicon under the existence of carbon dioxide as shown in Expression (2) or (3).
Li₄SiO₄+2CO₂ [symbol] 2Li₂CO₃+SiO₂+Q (2)
Li₄SiO₄+CO₂ [symbol] Li₂CO₃+Li₂SiO₃+Q (3)

When a rightward reaction occurs in Expressions (2) and (3), carbon dioxide reacts with lithium silicate and is absorbed thereby. The speed of the reactions for absorbing the carbon dioxide is maximized at about 600° C. These reactions are exothermal reactions.

When the inorganic carbon dioxide absorbent exists in the reaction field in the steam reforming reaction shown by Expression (1), the hydrogen yield is improved by the carbon dioxide absorbent which absorbs carbon dioxide as well as a heat loss can be lowered because the heat necessary to generate hydrogen can be compensated by the heat generated by the carbon dioxide absorbent when it absorbs the carbon dioxide.

According to an other aspect of the present invention, there is provided with the reaction chamber and the carbon dioxide absorbent chamber which are disposed independently of each other. The reaction chamber includes a catalyst for causing the reaction for generating the gas (first gas) containing hydrogen as the main product and carbon dioxide as the by-product from the material gas, and the carbon dioxide absorbent chamber includes the carbon dioxide absorbent for generating the gas (second gas) mainly containing hydrogen by selectively absorbing the carbon dioxide as the by-product from the first gas. With the above arrangement, the material gas sequentially passes through the respective chambers as the first and second gases while changing its composition. Accordingly, it is possible to suppress the deterioration of capability of the apparatus when the apparatus is used for a long period as compared with the conventional apparatus disclosed in Patent Document 1 in which the catalyst and the carbon dioxide absorbent exist in the same chamber in a mixed state.

According to the embodiment of the present invention, since the carbon dioxide absorbent chamber is connected to the reaction chamber on the rear side thereof, the gas, which has passed through the reaction chamber, is almost entirely introduced into the carbon dioxide absorbent chamber, thereby the absorbing ratio of carbon dioxide is improved, and thus the recovery ratio of the hydrogen can be more improved than the conventional apparatus which is disclosed in Patent Document 2 and in which only a part of the gas generated in a reaction chamber passes through a carbon dioxide chamber.

Further, according to the embodiment of the present invention, the reaction chamber is disposed adjacent to the carbon dioxide absorbent chamber, that is, they are directly connected to each other although the reaction chamber is separated from the carbon dioxide absorbent chamber by, for example, a wall. Therefore, the embodiment has an operation/working effect that heat is exchanged between both the chambers and the heat necessary to generate hydrogen can be compensated by the heat generated by the carbon dioxide absorbent when it absorbs carbon dioxide.

### BRIEF DESCRIPTION OF THE SEVERAL VIEWS OF THE DRAWINGS

FIG. 1 is a schematic view showing an embodiment of a chemical reaction apparatus of the present invention;

FIG. 2 is a schematic view showing an embodiment of the chemical reaction apparatus of the present invention;

FIG. 3 is a schematic view showing an embodiment of the chemical reaction apparatus of the present invention;

FIG. 4 is a schematic view showing an embodiment of a chemical reaction apparatus of a comparative example;

FIG. 5 is a schematic view showing an embodiment of a chemical reaction apparatus of a comparative example;

FIG. 6 is a schematic view showing an embodiment of a chemical reaction apparatus of a comparative example;

FIG. 7 is a schematic view showing an embodiment of a chemical reaction apparatus of a comparative example; and

FIG. 8 is a characteristic view showing a change of hydrogen generation capability when the chemical reaction apparatuses are used repeatedly in the present invention and the comparative examples.

### DETAILED DESCRIPTION OF THE INVENTION

### FIRST EMBODIMENT

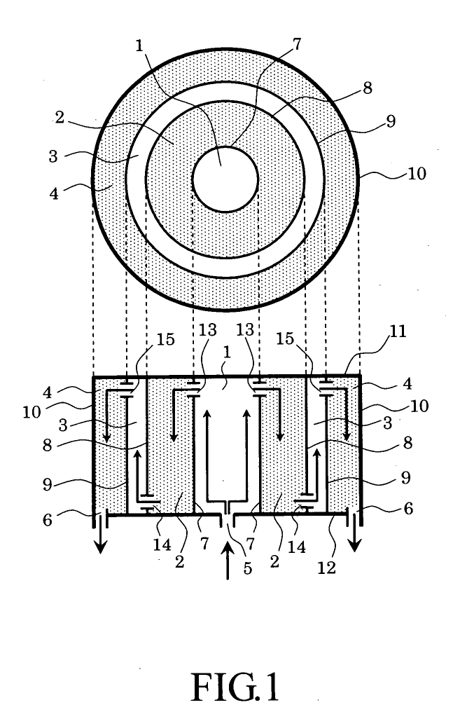

FIG. 1 is a schematic view showing a first embodiment of a chemical reaction apparatus of the present invention. In FIG. 1, an upper figure shows a sectional view of the chemical reaction apparatus when it is observed from an upper direction, and a lower figure is a sectional view thereof when it is observed from a lateral direction.

The chemical reaction apparatus includes first and second reaction chambers 1 and 3 each of which has a catalyst installed therein so that the catalysts cause a reaction for generating a gas containing hydrogen as a main product and carbon dioxide as a by-product from a material gas and first and second carbon dioxide absorbent chambers 2 and 4 acting as regions each of which has a carbon dioxide absorbent installed therein.

The first reaction chamber 1 has a material gas introduction pipe connected thereto. This pipe acts as a material gas introduction port 5. The second carbon dioxide absorbent chamber 4 has a generated gas exhaust pipe connected thereto. This pipe acts as a generated gas exhaust port 6.

The first reaction chamber 1 is separated from the first carbon dioxide absorbent chamber 2 by an inner wall 7 of the reaction apparatus, the first carbon dioxide absorbent chamber 2 is separated from the second reaction chamber 3 by an inner wall 8 of the reaction apparatus, and the second reaction chamber 3 is separated from the second carbon dioxide absorbent chamber 4 by an inner wall 9 of the reaction apparatus, respectively, and the chemical reaction apparatus is covered with an outside wall 10, a ceiling 11, and a bottom 12 in its entirety.

The inner walls 7, 8, 9 are formed of a material having a high heat conductivity so that heat can be effectively exchanged between regions adjacent to each other. The outside wall 10, the ceiling 11, and the bottom 12 are formed of a material having a low heat conductivity to prevent the emission of heat to the outside.

The first reaction chamber 1, the first carbon dioxide absorbent chamber 2, the second reaction chamber 3, and the second carbon dioxide absorbent chamber 4 are disposed adjacent to each other in a horizontal direction in this order from the inside of the reaction apparatus. In particular, the first carbon dioxide absorbent chamber 2 surrounds the first reaction chamber 1, the second reaction chamber 3 surrounds the first carbon dioxide absorbent chamber 2, and the second carbon dioxide absorbent chamber 4 surrounds the second reaction chamber 3, respectively.

The inner walls 7, 8, 9 and the outside wall 10 are formed in a cylindrical shape, the reaction chamber 1 at the center is composed of a column chamber, and the second reaction chamber 3 and the first and second carbon dioxide absorbent chambers 2 and 4 are composed of hollow column chambers. These walls and chambers are arranged concentrically. Since the respective chambers have the concentric structure, the contact areas between the respective regions are increased, thereby heat conduction is accelerated between the respective regions. Although the inner walls 7, 8, 9 and the outside wall 10 may be formed in any shape other than the cylindrical shape, it is desirable that they be formed in the cylindrical shape to conduct heat uniformly.

Holes 13 are defined through the inner wall 7, which separates the first reaction chamber 1 from the first carbon dioxide absorbent chamber 2, holes 14 are defined through the inner wall 8, which separates the first carbon dioxide absorbent chamber 2 from the second reaction chamber 3, and holes 15 are defined through the inner wall 9, which separates the second reaction chamber 3 from the second carbon dioxide absorbent chamber 4, respectively in order to connect adjacent chambers to each other. The material gas introduction port 5 is defined through the bottom of the first reaction chamber 1. Further, the generated gas exhaust port 6 is defined through the bottom of the second carbon dioxide absorbent chamber 4.

The material gas flows through the first reaction chamber 1, the first carbon dioxide absorbent chamber 2, the second reaction chamber 3, and the second carbon dioxide absorbent chamber 4 in this order in the directions shown by arrows, and the composition of the material gas is changed by the chemical reactions occurred in the respective chambers.

First, the material gas, which is supplied from the material gas introduction port 5, flows in the first reaction chamber 1 in the upward direction shown by arrows and executes an endothermic reaction in the first reaction chamber 1, thereby the material gas is changed to a first gas whose composition is composed of hydrogen as a main product, carbon dioxide as a by-product and other components.

In this embodiment, no heater is installed in the chemical reaction apparatus, and when a high temperature material gas, for example, a gas mixture composed of methane and steam is supplied from the material gas introduction port 5, the inside of the reaction apparatus is increased to a reaction temperature by supplying the gas of about 600° C. However, a heater may be installed to subsidiarily heat the gas.

The first gas, which has been generated in the first reaction chamber 1, further flows in the first reaction chamber 1 in the upward direction shown by the arrows, passes through the holes 13 acting as gas flow holes defined through the inner wall 7 at an upper portion thereof, and flows into the first carbon dioxide absorbent chamber 2.

The holes 13 may be holes defined through the inner wall 7 around an upper portion thereof at predetermined intervals in a band shape or may be net-shaped or lattice-shaped portions formed around an upper portion of the inner wall 7. Otherwise, the uppermost end of the inner wall 7 may not be in contact with the ceiling 11, and the height of the upper end of a catalyst layer filling the first reaction chamber 1 and the height of the uppermost end of an absorbent layer filling the first carbon dioxide absorbent chamber 2 may be equal to and lower than the height of the uppermost end of the inner wall 7. The holes 15, which are defined through the inner wall 9 and connect the second reaction chamber 3 to the second carbon dioxide absorbent chamber 4, have the same shape as the holes 13.

The first gas, which has flown into the first carbon dioxide absorbent chamber 2, flows therein in the downward direction shown by arrows, and is caused to execute an exothermic reaction by a carbon dioxide absorbent disposed in the first carbon dioxide absorbent chamber 2, thereby carbon dioxide is removed from the first gas, and thus the first gas changes to a second gas having a carbon dioxide concentration lower than that of the first gas. The second gas, which has been generated in the first carbon dioxide absorbent chamber 2, further flows in the first carbon dioxide absorbent chamber 2 in the downward direction shown by the arrows, passes through the holes 14, which are defined through the inner wall 8 at the lower portion thereof and act as the gas flow holes, and flows into the reaction chamber 3.

The holes 14 may be holes defined through the inner wall 8 around a lower portion thereof at predetermined intervals in a band shape or may be net-shaped or lattice-shaped portions formed around a lower portion of the inner wall 8. Otherwise, the lowermost end of the inner wall 8 may not be in contact with the bottom 12, and the height of the lowermost end of a carbon dioxide absorbent layer filling the first carbon dioxide absorbent chamber 2 and the height of the lowermost end of a catalyst layer filling the second reaction chamber 3 may be equal to and higher than the height of the lowermost end of the inner wall 8.

The holes 13, 14, and 15 may have a different density or a different number and further may have a different area in the band-shaped portions in which the holes are defined at the predetermined intervals and in the net- or lattice-shaped portions around the walls. That is, the holes 13, 14, and 15 may have a different total area.

Although the gases, which pass through the respective holes, have a different volume flow rate depending on the compositions, temperatures, and pressures thereof, it is desirable that holes, through which a gas passes at a large flow rate, have a large total area and that holes, through which a gas passes at a small flow rate, have a small total area.

Further, the second gas, which has flown into the reaction chamber 3, flows therein in the upward direction shown by arrows likewise the first reaction chamber 1, hydrogen as the main product and carbon dioxide as the by-product are generated from a non-reacted material gas contained in the second gas, thereby the second gas is converted into a third gas that contains a small amount of a non-reacted material gas component. The third gas flows into the second carbon dioxide absorbent chamber 4 through the holes 15 which are defined through the inner wall 9 and connect the second reaction chamber 3 to the second carbon dioxide absorbent chamber 4.

Further, the third gas, which has flown into the second carbon dioxide absorbent chamber 4, flows therein in the downward direction shown by arrows likewise in the first carbon dioxide absorbent chamber 2 so that carbon dioxide contained in the third gas is absorbed, thereby the third gas is converted into a fourth gas having a high hydrogen concentration. The fourth gas is recovered from the generated gas exhaust port 6.

In the embodiment, the gases generated in the respective chambers pass through the holes defined through the inner walls. However, gas flow paths such as pipes and the like may be separately disposed to the respective chambers to connect adjacent chambers to each other, and the gases may pass through the gas flow paths in place of the holes defined through the walls.

In the embodiment, the plurality of reaction chambers and the plurality of carbon dioxide absorbent chambers are provided and further the plurality of gas flow holes are provided to connect them, and the material gas alternately passes through the reaction chamber 1, the carbon dioxide absorbent chamber 2, the reaction chamber 3, and the carbon dioxide absorbent chamber 4 sequentially in this order while changing its composition. In particular, the total hydrogen yield can be more improved by generating hydrogen from the non-reacting material gas. It should be noted that even an apparatus, which is provided with at least each one set of the reaction chamber and the carbon dioxide absorbent chamber, and even an apparatus, which is provided with at least each three sets of the reaction chambers and the carbon dioxide absorbent chambers, are also within the scope of the present invention.

In the embodiment, the gas flows in the reaction chamber 1 while losing its heat through the endothermic reaction so that the temperature of the upper portion of the gas becomes lower than the lower portion thereof. Accordingly, the density of the gas increases toward the upper portion of the gas, from which gas convection is caused by the density difference of the gas and the temperature distribution of the gas can be reduced in the reaction chamber 1.

Further, in the embodiment, the gases emit heat through the exothermic reaction in the carbon dioxide absorbent chambers 2 and 4. In contrast, since the catalysts execute the endothermic reaction in the reaction chambers 1 and 3, and the heat generated in the carbon dioxide absorbent chambers 2 and 4 is supplied to the reaction chambers 1 and 3 adjacent to each other through the inner walls 7, 8, 9, thereby a heat loss can be reduced in total.

Further, the heat generated in the carbon dioxide absorbent chamber 2 is supplied to the reaction chamber 1 through the inner walls 7 and 8. Accordingly, the temperature drop of the material gas from the time it passes through the material gas introduction port 5 of the reaction chamber 1 to the time it passes through the holes 13 becomes smaller than a case where the carbon dioxide absorbent chamber 2 is not filled with the carbon dioxide absorbent. Heat migration occurs also in the reaction chamber 3 likewise in the reaction chamber 1. Further, the temperature increase of the gas from the time it passes through the holes 13 of the first carbon dioxide absorbent chamber 2 to the time it passes through the holes 14 becomes smaller than a case where the reaction chambers 1 and 3 are not filled with the catalysts. Heat migration occurs also in the carbon dioxide absorbent chamber 4 likewise in the carbon dioxide absorbent chamber 2.

When lithium silicate is used as the carbon dioxide absorbent, the lithium silicate can be regenerated by discharging carbon dioxide from the carbon dioxide absorbent that has absorbed it because of the following reason. That is, as shown in Expressions (2) and (3) described above, the reaction between carbon dioxide and lithium silicate is a reversible reaction. Accordingly, lithium silicate can be regenerated by causing the carbon dioxide absorbent, which has absorbed carbon dioxide, to discharge it by executing a leftward reaction (hereinafter, referred to as “regeneration reaction”) in the expressions (2) and (3) by heating the carbon dioxide absorbent.

It is also possible to substantially continuously generate hydrogen making use of the property of lithium silicate as described above. That is, a system, in which a plurality of the chemical reaction apparatuses of the present invention are installed, is arranged. Hydrogen is substantially continuously generated by alternately executing an operation for generating hydrogen by any one of the apparatuses in the system and regenerating lithium silicate by the remaining apparatuses in the system. Further, when the lithium silicate is regenerated under a carbon dioxide atmosphere, discharged carbon dioxide can be utilized because it has a high purity unlikely a case where it is regenerated under, for example, a nitrogen atmosphere.

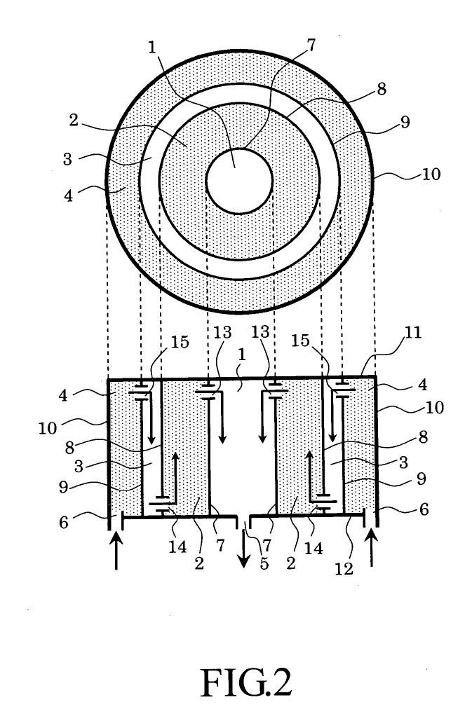

A method of regenerating the carbon dioxide absorbent, which have absorbed carbon dioxide, by discharging carbon dioxide therefrom after a reaction is executed to generate hydrogen from the material gas using the chemical reaction apparatus according to the embodiment of the present invention, will be explained with reference to FIGS. 1 and 2.

FIG. 2 is a view showing a chemical reaction apparatus similar to the chemical reaction apparatus shown in FIG. 1. Reference numerals 1 to 15 shown in FIG. 2 denote the same terms as those denoted by the reference numerals 1 to 15 shown in FIG. 1.

When a regeneration reaction is caused in the carbon dioxide absorbent, which have absorbed carbon dioxide, using the chemical reaction apparatuses shown in FIGS. 1 and 2, a gas, for example, a carbon dioxide gas is supplied from the material gas introduction port 5 (FIG. 1) acting as an inlet or from a generated gas discharge port 6 (FIG. 2), to the respective chambers in order to transport discharged carbon dioxide, the regeneration reaction is caused in the carbon dioxide absorbents in the carbon dioxide absorbent chambers 2 and 4, and a gas containing carbon dioxide is discharged from the generated gas discharge port 6 (FIG. 1) acting as an outlet or from a material gas introduction port 5 (FIG. 2).

At the time, the gas, which passes through the carbon dioxide absorbent chambers 2 and 4, must be heated to cause the regeneration reaction as an endothermic reaction in the carbon dioxide absorbents. The gas supplied to the respective chambers may be heated using a heater (not shown), and when the heater is not installed, the insides of the reaction apparatuses are increased to a regeneration temperature by introducing the gas after it is heated to a high temperature. It is desirable that the gas supplied to the carbon dioxide absorbent chambers 2 and 4 has a temperature equal to or higher than 720° C. and equal to or lower than 1000° C. at atmospheric pressure when, for example, lithium silicate is used as the carbon dioxide absorbent.

At this time, the gas may flow in the same directions as those shown by the arrows in the respective chambers in FIG. 1 or may flow in the directions opposite to those in FIG. 1 as shown by arrows in respective chambers of FIG. 2.

However, since the regeneration reaction executed in the carbon dioxide absorbent is the endothermic reaction, the gas flows in the carbon dioxide absorbent chambers 2 and 4 while losing its heat. Accordingly, when the gas flows in the same directions as those of FIG. 1, the gas flows in the downward direction in the carbon dioxide absorbent chambers 2 and 4, thereby the temperature of the gas is higher in an upper portion than in a lower portion. Thus, since the density of the gas increases toward downward, gas convection is difficult to be caused by a density difference, and thus a pressure difference caused in the carbon dioxide absorbent chambers 2 and 4 becomes smaller than a case where the gas flows in the upward direction.

In contrast, when the gas flows in the direction shown in FIG. 2, the gas flows in the upward direction in the carbon dioxide absorbent chambers 2 and 4, thereby the temperature of the gas is higher in the lower portion than in the upper portion. Accordingly, since the density of the gas becomes higher toward upward, gas convection is caused by a density difference and heat migrates, thereby the temperature distribution of the gas can be reduced in the carbon dioxide absorbent chambers 2 and 4.

An optimum gas flow direction is determined depending on the shapes of the catalyst and the carbon dioxide absorbent, the flow rate and the temperature of the gas, the material, the shape of a reactor, and the like.

### SECOND EMBODIMENT

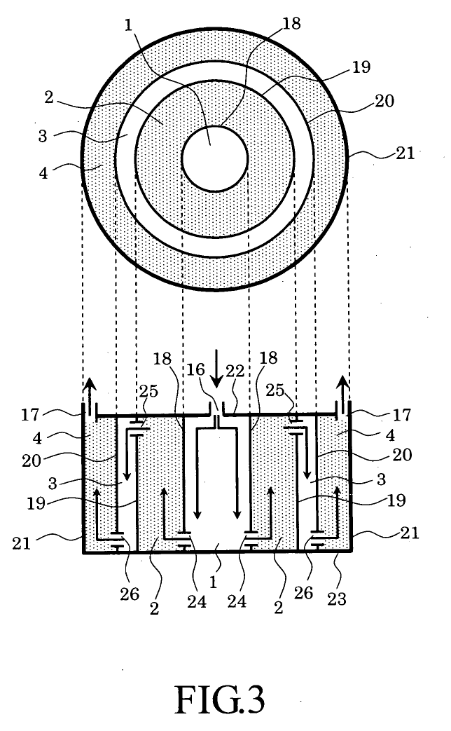

FIG. 3 is a schematic view showing a second embodiment of the chemical reaction apparatus of the present invention. In FIG. 3, an upper figure shows a sectional view of the chemical reaction apparatus when it is observed from an upper direction, and a lower figure is a sectional view thereof when it is observed from a lateral direction. The second embodiment has the same arrangement as that of the first embodiment except that the directions in which gases flow are changed by changing the positions of gas introduction and discharge ports. The chemical reaction apparatus includes first and second reaction chambers 1 and 3 acting as catalyst regions each of which is filled with a catalyst so that the catalysts cause a reaction for generating a gas containing hydrogen as a main product and carbon dioxide as a by-product from a material gas and first and second carbon dioxide absorbent chambers 2 and 4 acting as carbon dioxide absorbent regions each of which is filled with a carbon dioxide absorbent. This arrangement is the same as that of the first embodiment. The first reaction chamber 1 has a material gas introduction pipe connected thereto. This pipe acts as a material gas introduction port 16. The second carbon dioxide absorbent chamber 4 has a generated gas exhaust pipe connected thereto. This pipe acts as a generated gas exhaust port 17.

The first reaction chamber 1 is separated from the first carbon dioxide absorbent chamber 2 by an inner wall 18 of the reaction apparatus, the first carbon dioxide absorbent chamber 2 is separated from the second reaction chamber 3 by an inner wall 19 of the reaction apparatus, and the second reaction chamber 3 is separated from the second carbon dioxide absorbent chamber 4 by an inner wall 20 of the reaction apparatus, respectively, and the chemical reaction apparatus is covered with an outside wall 21, a ceiling 22, and a bottom 23 in its entirety.

The inner walls 18, 19, 20 are formed of a material having a high heat conductivity so that heat can be effectively exchanged between regions adjacent to each other. The outside wall 21, the ceiling 22, and the bottom 23 are formed of a material having a low heat conductivity to prevent the emission of heat to the outside.

The reaction chamber 1, the carbon dioxide absorbent chamber 2, the reaction chamber 3, and the carbon dioxide absorbent chamber 4 are disposed adjacent to each other in a horizontal direction in this order from the inside of the reaction apparatus likewise the first embodiment, the carbon dioxide absorbent chamber 2 surrounds the reaction chamber 1, the reaction chamber 3 surrounds the carbon dioxide absorbent chamber 2, and the carbon dioxide absorbent chamber 4 surrounds the reaction chamber 3, respectively.

The inner walls 18, 19, and 20 and the outside wall 21 are formed in a cylindrical shape, and thus the reaction chamber 1 at the center is composed of a column chamber, and the reaction chamber 3 and the carbon dioxide absorbent chambers 2 and 4 are composed of hollow column chambers. These walls and chambers are arranged concentrically similarly to the first embodiment.

Holes 24 are defined through the inner wall 18, which separates the reaction chamber 1 from the carbon dioxide absorbent chamber 2, holes 25 are defined through the inner wall 19, which separates the carbon dioxide absorbent chamber 2 from the reaction chamber 3, and holes 26 are defined through the inner wall 20, which separates the reaction chamber 3 from the carbon dioxide absorbent chamber 4, respectively in order to connect adjacent chambers to each other. A material gas exhaust port 16 is defined through the ceiling of the reaction chamber 1. Further, a generated gas exhaust port 17 is defined through the ceiling of the carbon dioxide absorbent chamber 4.

The material gas flows in the reaction chamber 1, the carbon dioxide absorbent chamber 2, the reaction chamber 3, and the carbon dioxide absorbent chamber 4 in this order in the directions shown by arrows in the respective chambers, and the composition of the material gas is changed by the chemical reactions occurred in the respective chambers.

The material gas, which is supplied from the generated gas exhaust port 16, flows in the reaction chamber 1 in the downward direction shown by arrows, executes an endothermic reaction in the reaction chamber 1, thereby a first gas, which is composed of hydrogen as a main product gas, carbon dioxide as a by-product gas and other components, is generated. The first gas, which has been generated in the reaction chamber 1, further flows in the reaction chamber 1 in the downward direction shown by the arrows, passes through holes 24, which are defined through the inner wall 18 at a lower portion thereof and act as gas flow holes, and flows into the carbon dioxide absorbent chamber 2.

Since the first gas executes a reaction in the carbon dioxide absorbent chamber 2, carbon dioxide is removed from the first gas together with the heat generated by the carbon dioxide absorbent, thereby the first gas is converted into a second gas having a carbon dioxide concentration lower than the first gas. The second gas, which has been generated in carbon dioxide absorbent chamber 2, further flows therein in the upward direction shown by arrows, passes through holes 25 that act as gas flow holes defined through the inner wall 19 at an upper portion thereof, and flows into the reaction chamber 3.

Further, the second gas, which has flown into the reaction chamber 3, flows in the reaction chamber 3 in the downward direction shown by arrows likewise in the first reaction chamber 1, hydrogen as the main product and carbon dioxide as the by-product are generated from a non-reacted material gas contained in the second gas, thereby the second gas is converted into a third gas that contains a smaller amount of the non-reacted material gas. The third gas flows into the carbon dioxide absorbent chamber 4 passing through the holes 26 which are defined through the inner wall 20 and connect the reaction chamber 3 to the carbon dioxide absorbent chamber 4.

Further, the third gas, which has flown into the carbon dioxide absorbent chamber 4, flows therein in the upward direction shown by arrows likewise in the carbon dioxide absorbent chamber 2 so that the carbon dioxide contained in the third gas is absorbed, thereby the third gas is converted into a fourth gas having a higher hydrogen concentration. The fourth gas is recovered from the generated gas exhaust port 17.

In the embodiment, the gas flows in the reaction chamber 1 while losing its heat due to the endothermic reaction so that the temperature of the lower portion of the gas becomes lower than the upper portion thereof. Thus, since the density of the gas increases toward the lower portion, gas convection is difficult to be caused by a density difference, and thus a pressure difference caused in the reaction chamber 1 becomes smaller than a case where the gas flows in an upward direction as in the first embodiment.

In the second embodiment, the shape and the like of the holes 24 to 26 may be modified likewise the first embodiment. Further, the gases may flow into the respective chambers through gas flow paths such as pipes and the like that are disposed to connect the respective chambers in place of the holes defined through the walls for separating the respective chambers from each other.

In the embodiments of the present invention, gas mixtures, which composed of hydrocarbon, oxygen containing hydrocarbon, alcohols, and carbon monoxide mixed with steam, can be used as the material gas from which hydrogen as the main product gas and carbon dioxide as the by-product gas are obtained through a chemical reaction.

Further, in the embodiments of the present invention, when the material gas contains methane and steam, it is desirable that the reaction chambers be filled with a nickel catalyst such as metal nickel as the catalyst for obtain the hydrogen as the main product gas and the carbon dioxide as the by-product gas by chemically reacting the material gas. Otherwise, iron oxides such as ferric oxide and iron-chromium composite oxides may be mixed with the rear stages of the gas flow paths. When the material gas contains carbon monoxide and steam, iron oxides such as ferric oxide and iron-chromium composite oxides are preferably used.

Further, although any material can be used as the carbon dioxide absorbent for selectively absorbing carbon dioxide as long as it selectively absorbs the carbon dioxide, lithium zirconate, lithium silicate, and the like are exemplified as the carbon dioxide absorbent, and the lithium silicate is particularly desirable because it can be regenerated. A pellet-like lithium silicate is preferably used as the carbon dioxide absorbent. A pellet-like carbon dioxide absorbent is composed of a green compact of lithium silicate which is made by pressurizing, for example, lithium silicate powder.

In the embodiments of the present invention, it is desirable to use a catalyst material which fills carrier particles composed of an inorganic material such as alumina and the like. Further, it is desirable to fill the reaction chamber with the carrier particles filled with the catalyst and form a layer of the carrier particles in the reaction chamber and to form layers, each of which is filled with a particle-like inorganic material similar to the carriers, on and under the above layer. It is desirable that the particle-like inorganic material be composed of a material having durability to a maximum inside temperature when the reaction apparatus is operated, and alumina balls, for example, are exemplified as the particle-like inorganic material. The layer filled with the particle-like inorganic material makes a gas flow uniform.

Further, as to the carbon dioxide absorbent, it is desirable to fill the carbon dioxide absorbent chamber with carbon dioxide absorbent particles and to form a layer of the particles in the carbon dioxide absorbent chamber, and to form layers, each of which is filled with the particle-like inorganic material described above, on and under the above layer.

When methane is reformed using steam according to the present invention, there is contemplated a system for generating power using a generated hydrogen-containing gas in a fuel cell, a boiler, a gas turbine, and the like as an example. When a carbon dioxide absorbent is used in a steam reformer of the system in addition to a catalyst as described above, it is possible to separate carbon dioxide while obtaining a heat efficiency equal to or more than that of a system in which only the catalyst is used in the steam reformer or a system which is used in a boiler, a gas turbine, and the like and in which methane is directly combusted.

Further, the present invention is by no means limited to the first and second embodiments described above and can be variously modified according to various applications when necessary so that they can be used for them.

Examples of the present invention will be described below in detail.

### EXAMPLE 1

Hydrogen was generated using the chemical reaction apparatus shown in FIG. 1.

Each of reactors had inner walls 7, 8, 9 and an outer wall 10 each formed in a cylindrical shape, the inner wall 7 had an inside diameter of 0.25 m, the inner wall 8 had an inside diameter of 0.75 m, the inner wall 9 had an inside diameter of 0.80 m, and the outside wall 10 had an inside diameter of 1.05 m. The inner walls 7, 8, 9 had a thickness set to about 0.005 m. Further, each of the reactors had a bottom and a ceiling therein which were separated from each other by a distance of 1.7 m, holes each having a diameter of 3 mm and distributed uniformly around the inner walls 7 and 9 in a band shape at a position of 0.1 m to 0.2 m below the ceiling, and holes each having a diameter of 3 mm and distributed uniformly around the inner wall 8 in a band shape at a position of 0.05 m to 0.15 m above the bottom.

Alumina particles, which carried about 20 wt % of metal nickel and had an average particle size of 5 mm, were used as a reforming solid catalyst. Pellet-like green powder having a diameter of 5 mm and a length of 8 mm, which was made by pressurizing and molding lithium silicate powder, was used as a carbon dioxide absorbent.

Alumina balls having an average particle size of 5 mm filled reaction chambers 1 and 3 and carbon dioxide absorbent chambers 2 and 4 in a height of 0.1 m from the bottoms thereof, catalysts and carbon dioxide absorbents filled the spaces on the alumina balls in a height of about 0.2 m below the ceilings thereof, respectively, and alumina balls having an average particle size of 5 mm filled the spaces on the catalysts and the carbon dioxide absorbents in a height of 0.1 m below the ceilings thereof. The solid catalysts were used in a total amount of 150 kg, and the carbon dioxide absorbents were used in a total amount of 600 kg.

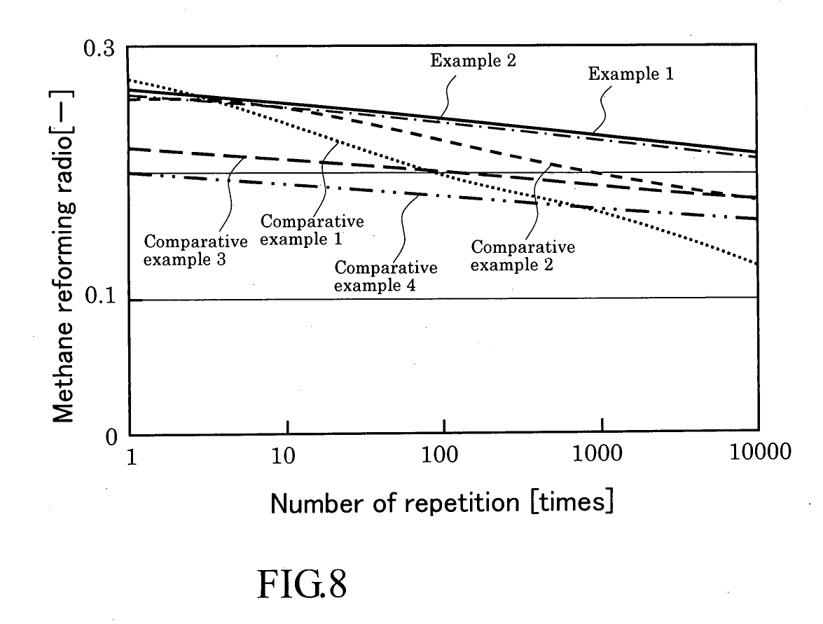

When hydrogen was generated, gases were flown in the directions shown in FIG. 1, and when the carbon dioxide absorbents were regenerated, the gases were flown in the directions shown in FIG. 2. When the gases are flown as described above, the deterioration of capability of the chemical reaction apparatus can be prevented even if it is used for a long period as shown in FIG. 8.

### EXAMPLE 2

Hydrogen was generated using the chemical reaction apparatus shown in FIG. 3.

Each of reactors had inner walls 18, 19, 20 and an outer wall 21 each formed in a cylindrical shape, the inner wall 18 had an inside diameter of 0.25 m, the inner wall 19 had an inside diameter of 0.75 m, the inner wall 20 had an inside diameter of 0.80 m, and the outside wall 21 has an inside diameter of 1.1 m. The inner walls 18, 19, 20 had a thickness set to about 0.005 m. Further, each of the reactors had a bottom and a ceiling therein which were separated from each other by a distance of 1.7 m, holes each having a diameter of 3 mm and distributed uniformly around the inner walls 18 and 20 in a band shape at a position of 0.05 m to 0.15 m above the bottom, and holes each having a diameter of 3 mm and distributed uniformly around the inner wall 19 in a band shape at a position of 0.1 m to 0.2 m below the ceiling.

The same reforming solid catalyst and the same carbon dioxide absorbent as those used in the example 1 were used. Alumina balls having an average particle size of 5 mm filled the reaction chambers 1 and 3 and carbon dioxide absorbent chambers 2 and 4 in a height of 0.1 m from the bottoms thereof, the catalysts and the carbon dioxide absorbents filled the spaces on the alumina balls in a height of about 0.2 m below the ceilings thereof, respectively, and the alumina balls having an average particle size of 5 mm filled the spaces on the catalysts and the carbon dioxide absorbents in a height of 0.1 m below the ceilings thereof. The solid catalysts were used in a total amount of 150 kg, and the carbon dioxide absorbents were used in a total amount of 600 kg.

When the carbon dioxide absorbents were regenerated, gases were flown in the directions shown in FIG. 3. When the gases are flown as described above, the deterioration of capability of the chemical reaction apparatus can be prevented even if it is used for a long period of time as shown in FIG. 8 likewise the example 1.

### COMPARATIVE EXAMPLE 1

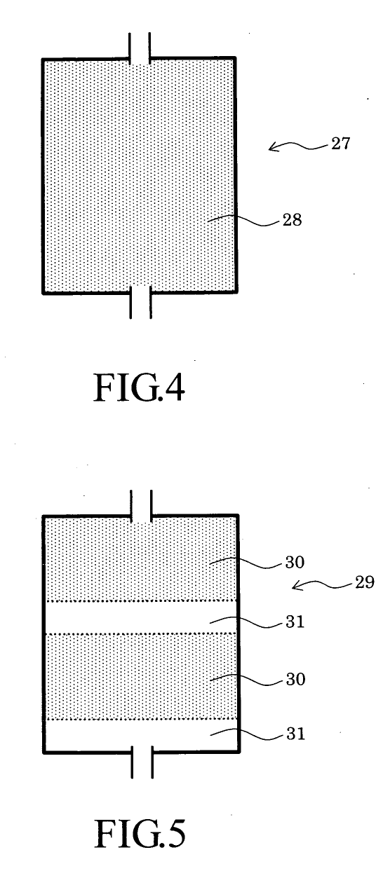

Hydrogen was generated using a chemical reaction apparatus shown in FIG. 4. In a comparative example 1, a catalyst and a carbon dioxide absorbent were used in a mixed state.

A reactor 27 was formed in a columnar shape and had an inside diameter of 1.1 mm and a distance between a bottom and a ceiling thereof set to 1.6 m. The same reforming solid catalyst and the same carbon dioxide absorbent as those used in the example 1 were used. Alumina balls having an average particle size of 5 mm filled the reaction chamber 27 in a height of 0.1 m from the bottom thereof, the catalyst of 150 kg and the carbon dioxide absorbent of 600 kg filled the space on the alumina balls after they were uniformly mixed with each other (mixed/filled layer 28), and the alumina balls having an average particle size of 5 mm filled the space on the mixed/filled layer 28 in a height of about 0.1 m. Gases flowed upward when hydrogen was generated and flowed downward when the carbon dioxide absorbents were regenerated.

### COMPARATIVE EXAMPLE 2

Hydrogen was generated using a chemical reaction apparatus shown in FIG. 5. In a comparative example 2, catalysts were not separated from carbon dioxide absorbents by a wall.

A reactor 29 was formed in a columnar shape and had an inside diameter of 1.03 m and a distance between a bottom and a ceiling thereof set to 1.6 m. The same reforming solid catalyst and the same carbon dioxide absorbent as those used in the example 1 were used. Alumina balls having an average particle size of 5 mm filled the space of the reaction apparatus 29 in a height of 0.1 m from the bottom thereof, the catalyst of 75 kg (catalyst filled layer 31), the carbon dioxide absorbent of 300 kg (carbon dioxide absorbent filled layer 30), the catalyst of 75 kg (catalyst filled layer 31), the carbon dioxide absorbent 31 of 300 kg (carbon dioxide absorbent filled layer 30) filled the space on the alumina balls in this order, and alumina balls having an average particle size of 5 mm filled thereon in a height of about 0.1 m. Gases flowed upward when hydrogen was generated and flowed downward when the carbon dioxide absorbents were regenerated.

### COMPARATIVE EXAMPLE 3

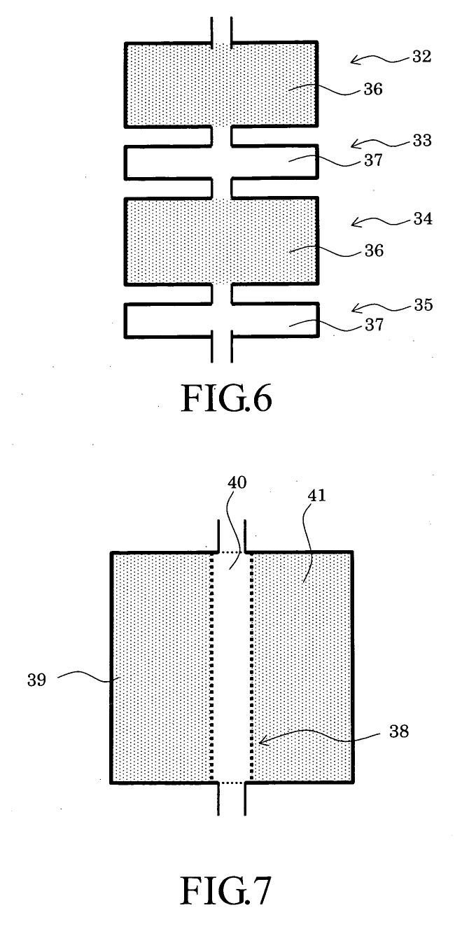

Hydrogen was generated using a chemical reaction apparatus shown in FIG. 6. A comparative example 3 was an example in which although reaction chambers and carbon dioxide absorbent chambers were separated by walls (surfaces)s, the respective chambers were not adjacent to each other.

Each of reactors 32, 33, 34, 35 was formed in a columnar shape and had an inside diameter of 1.1 m. A catalyst of 75 kg (catalyst filled layer 37) filled each of the reactors 32, 34, and alumina balls having an average particle size of 5 mm filled the space on and under each of the catalysts in a height of 0.1 m. A carbon dioxide absorbent of 300 kg (carbon dioxide absorbent filled layer 36) filled each of the reactors 33, 35, and the alumina balls having the average particle size of 5 mm filled the space on and under each of the carbon dioxide absorbents in a height of 0.1 m. The same reforming solid catalyst and the same carbon dioxide absorbent as those used in the example 1 were used. Gases flowed upward when hydrogen was generated and flowed downward when the carbon dioxide absorbents were regenerated.

### COMPARATIVE EXAMPLE 4

Hydrogen was generated using a chemical reaction apparatus shown in FIG. 7. A comparative example 4 is an example in which although a reaction chamber is disposed adjacent to a carbon dioxide absorbent chamber, that is, they are in direct contact with each other, only a part of a gas, which is reacted by a catalyst, passes through an outer tube.

A reactor had a double pipe structure, and an inner wall 38 and an outer wall 39 were formed in a cylindrical shape. The inner wall 38 was formed of a porous alumina pipe having a porosity of about 60% so that gas passed therethrough. The inner wall 38 had an inside diameter of 0.4 m, and the outer wall 39 had an inside diameter of 1.05 m. The inner walls 38 had a thickness set to about 0.02 m. Further, the reactor had a bottom and a ceiling therein which were separated from each other by a distance of 1.6 m. A catalyst of 150 kg (catalyst filled layer 40) filled the inside of the inner wall, and alumina balls having an average particle size of 5 mm filled the spaces on and under the catalyst in a height of 0.1 m, respectively. A carbon dioxide absorbent of 600 kg (carbon dioxide absorbent filled layer 41) filled the space between the inner wall and the outer wall, and alumina balls having an average particle size of 5 mm filled the spaces on and under the carbon dioxide absorbent in height of 0.1 m, respectively. The same reforming solid catalyst and the same carbon dioxide absorbent as those used in the example 1 were used. The gas flowed upward when hydrogen was generated and flowed downward when the carbon dioxide absorbent was regenerated.

H₂O and CH₄ as material gases were mixed at a ratio of H₂O/CH₄=4 (mol ratio), a resultant material gas was previously heated to 600° C. and introduced into the apparatuses of the examples 1, 2 and the comparative examples 1, 2, 3, 4 at a flow rate of 10 m³/min at standard conditions, and hydrogen was generated thereby. Further, regeneration was executed by introducing a carbon dioxide gas at a flow rate of 30 m³/min at standard conditions after it was previously heated to 900° C. Generation of hydrogen and regeneration of the carbon dioxide absorbent were alternately executed every 30 minutes and they were repeated 10,000 times. FIG. 8 shows the change of a hydrogen generation capability resulting from the alternate execution of the above operations by means of a methane reforming ratio shown in the following Expression (4) which shows the methane reforming ratio after 30 minutes have passed from the beginning of generation of hydrogen.
Methane reforming ratio=1−{(number of moles of CH₄ in finally generated gas discharged per second)/(number of moles of CH₄ in material gas introduced per second) (4)

The examples 1 and 2 were filled with the solid catalyst and the carbon dioxide absorbent in the state where the solid catalyst is separated from the carbon dioxide absorbent, and the comparative example 2 was filled with the solid catalyst and the carbon dioxide absorbent without mixing them. However, the examples 1 and 2 and the comparative example 2 exhibited the same hydrogen generation capability as that of the comparative example 1 which was filled with the solid catalyst and the carbon dioxide absorbent in a mixed state in a first repetition. Accordingly, it is found that a high hydrogen recovery ratio can be obtained by an effect of shifting chemical equilibrium also in the examples 1 and 2 and the comparative example 2 similarly to the comparative example 1 as well as the heat generated in the respective reactions can be effectively utilized.

In contrast, the comparative example 3 had a low hydrogen generation capability in a first repetition. It is supposed this is because the solid catalyst was completely separated from the carbon dioxide absorbent, the heat generated by a carbon dioxide absorbing reaction could not be effectively supplied to a reforming reaction and the methane reforming ratio was lowered thereby.

The comparative example 4 was inferior to the comparative example 3 in the hydrogen yield although it utilized heat more effectively than the comparative example 3. This is because the comparative example 4 disposed the solid catalyst filled layer adjacent to the carbon dioxide absorbent filled layer similarly to the examples 1 and 2.

Further, the capability of the examples 1 and 2 and the comparative example 1, 2, 3 and 4 was deteriorated through repetitions. As to the examples 1 and 2 and the comparative examples 3 and 4, it is supposed that an effect of using the carbon dioxide absorbent was lowered mainly due to the deterioration of the capability thereof. However, the capability was more deteriorated in the comparative examples 1 and 2 than in the examples 1 and 2 through repetitions.

Since, in the comparative example 1, the solid catalyst and the carbon dioxide absorbent were filled after being mixed with each other, the molten carbonate generated in the carbon dioxide absorbent moved to the solid catalyst through repetitions. Accordingly, the metal nickel in the solid catalyst was covered with the molten carbonate, thereby the capability of the solid catalyst was deteriorated. Further, the absorption capability of the carbon dioxide absorbent was deteriorated as well as the strength thereof was lowered, and the carbon dioxide absorbent was partly collapsed because it lost the carbonate. As a result, the methane reforming ratio was lowered.

Since the number of points where the solid catalyst was in contact with the carbon dioxide absorbent was smaller in the comparative example 2 than in the comparative example 1, the effect of movement of the molten carbonate was small when the number of repetitions was small. However, the difference of the effects between the comparative example 2 and the examples 1 and 2 became outstanding when the number of repetitions increased. To obtain an effect of shifting the chemical equilibrium even if the gas flow rate is large, a multiplicity of rectors each filled with the catalyst and a multiplicity of rectors each filled with the carbon dioxide absorbent must be alternately installed in a gas flow direction, thereby the overall volume of the apparatus is increased. Further, since a space is formed between the respective reactors, when a heat exchange is executed only by the sensible heat of the gas, a heat utilizing efficiency is deteriorated and a heat loss occurs.

Advantages

Accordingly, the embodiments of the present invention can provide a chemical reaction apparatus that does not deteriorate the hydrogen yield when the apparatus is used for a long period as compared with a conventional apparatus in a chemical reaction apparatus employing a system for improving the hydrogen yield as a main product by absorbing carbon dioxide as a by-product using a carbon dioxide absorbent in a reaction process for generating hydrogen from a material gas.

1. A chemical reaction apparatus comprising:
a reaction chamber which generates a first gas containing hydrogen as a main product and carbon dioxide as a by-product by causing a material gas to come into contact with a catalyst; and
a carbon dioxide absorbent chamber disposed adjacent to the reaction chamber, having one of a gas flow path or a gas flow hole for introducing the first gas generated in the reaction chamber there into, generating a second gas by selectively absorbing the carbon dioxide as the by-product from the first gas by a carbon dioxide absorbent, and having a generated gas discharge port which takes out the second gas,
wherein the carbon dioxide absorbent chamber is disposed behind the reaction chamber.

2. A chemical reaction apparatus according to claim 1, wherein the carbon dioxide absorbent chamber surrounds the reaction chamber.

3. A chemical reaction apparatus according to claim 2, wherein a wall for separating the reaction chamber from the carbon dioxide absorbent chamber and the outside wall of the carbon dioxide absorbent chamber are arranged concentrically.

4. A chemical reaction apparatus according to claim 1, wherein the reaction chamber surrounds the carbon dioxide absorbent chamber.

5. A chemical reaction apparatus according to claim 4, wherein a wall for separating the reaction chamber from the carbon dioxide absorbent chamber and the outside wall of the reaction chamber are arranged concentrically.

6. A chemical reaction apparatus according to claim 1, wherein a wall for separating the reaction chamber from the carbon dioxide absorbent chamber comprises a material having a high heat conductivity.

7. A chemical reaction apparatus according to claim 2, wherein an outer wall of the carbon dioxide absorbent chamber comprises a material having a low heat conductivity.

8. A chemical reaction apparatus according to claim 4, wherein the outer wall of the reaction chamber comprises a material having a low heat conductivity.

9. A chemical reaction apparatus according to claim 1, wherein a material gas supply port for supplying the material gas into the reaction chamber is disposed in a lower portion of the reaction chamber, the one of the gas flow path or the gas flow hole is disposed in an upper portion of the reaction chamber, and the generated gas discharge port is disposed in a lower portion of the carbon dioxide absorbent chamber.

10. A chemical reaction apparatus according to claim 1, wherein the material gas supply port for supplying the material gas into the reaction chamber is disposed in an upper portion of the reaction chamber, the one of the gas flow path or the gas flow hole is disposed in a lower portion of the reaction chamber, and the generated gas discharge port is disposed in an upper portion of the carbon dioxide absorbent chamber.

11. A chemical reaction apparatus according to claim 10, wherein the upper surfaces of the reaction chamber and the carbon dioxide absorbent chamber are covered with ceilings, the lower surfaces thereof are covered with bottoms, and the ceilings and the bottoms comprise a material having a low heat conductivity.

12. A chemical reaction apparatus according to claim 1, wherein a plurality of the reaction chambers, a plurality of ones of the gas flow paths and the gas flow holes, and a plurality of the carbon dioxide absorbent chambers are provided, respectively, and the material gas alternately passes through the reaction chambers and the carbon dioxide absorbent chambers while changing its composition.

13. A chemical reaction apparatus according to claim 12, wherein the upper surfaces of the reaction chambers and the carbon dioxide absorbent chambers are covered with ceilings, the lower surfaces thereof are covered with bottoms, and the ceilings and the bottoms comprise a material having a low heat conductivity.

14. A chemical reaction apparatus according to claim 1, wherein a plurality of the reaction chambers and a plurality of the carbon dioxide absorbent chambers are provided, respectively, and the reaction chambers and the carbon dioxide absorbent chambers are disposed alternately adjacent to each other.

15. A chemical reaction apparatus according to claim 1, wherein the carbon dioxide absorbent chamber is filled with a pellet-like carbon dioxide absorbent.

16. A chemical reaction apparatus according to claim 1, wherein the carbon dioxide absorbent is lithium silicate.

17. A chemical reaction apparatus according to claim 1, wherein the carbon dioxide absorbent is lithium zirconate.

18. A chemical reaction apparatus according to claim 1, wherein a space in the vicinity of one of the gas flow path or the gas flow hole of the carbon dioxide absorbent chamber is filled with alumina balls.

19. A chemical reaction apparatus according to claim 1, wherein alumina balls fill a sapce in the vicinity of the generated gas discharge port of the carbon dioxide absorbent chamber.

20. A chemical reaction apparatus according to claim 10, wherein alumina balls fill the lower portion and the upper portion of the carbon dioxide absorbent chamber in a layer state, respectively.

21. A chemical reaction apparatus according to claim 12, wherein alumina balls fill the lower portion and the upper portion of the carbon dioxide absorbent chamber in a layer state, respectively.
